(19) United States
(12) Patent Application Publication
(10) Pub. No.: US 2006/0218342 A1
(43) Pub. Date: Sep. 28, 2006

(54) Processing method for preventing anomalies when reading device-specific information for media storage device, and media storage device

(75) Inventors: Takehiro Ogawa, Kawasaki (JP); Yoshinori Inoue, Kawasaki (JP); Hiroaki Murai, Kawasaki (JP); Satoru Fukase, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/217,726

(22) Filed: Sep. 1, 2005

(30) Foreign Application Priority Data
Mar. 25, 2005 (JP) 2005-89642

(51) Int. Cl. G06F 13/28

(52) U.S. Cl. 711/112

(57) ABSTRACT

A media storage device reads device-specific information from media into memory and performs read/write operations to and from media. In an idle loop after turning on power to a media storage device, a MPU performs processing to update device-specific information while command processing is not being performed, preventing loss of device-specific information due to a sudden cutoff of power. The MPU reads the updated device-specific information from the media while command processing is not being performed, to execute read tests.

### CROSS-REFERENCE TO RELATED APPLICATIONS

This application is based upon and claims the benefit of priority from the prior Japanese Patent Application No. 2005-089642, filed on Mar. 25, 2005, the entire contents of which are incorporated herein by reference.

### BACKGROUND OF THE INVENTION

1. Field of the Invention

This invention relates to a processing method for prevention of anomalies when reading device-specific information, in which device-specific information stored on media is expanded into memory and operations are performed based on this information, and to a media storage device. In particular, this invention relates to a preventive processing method for device-specific information to perform processing for the prevention of errors when reading device-specific information stored on and updated on media, and a media storage device.

2. Description of the Related Art

Demands for electronic processing of data in recent years have led to requests for larger capacities in media storage devices such as magnetic media storage and optical media storage to store data. Consequently the track densities and recording densities of disk storage media continue to rise. In such disk storage devices, it is essential that the state of the media and the read/write state be monitored, and to this end device-specific information is stored on disks, which are nonvolatile memory, for each device.

This device-specific information is information which is updated. For example, when automatic replacement processing occurs in magnetic storage devices, the addresses of the error sector (replacement source sector) and the replacement target sector to replace the former are registered in defective sector management information, and must be maintained even when power is turned off (see for example Japanese Patent Laid-open No. 4-245072).

In SMART (Self-Monitoring Analysis Report Technology) drive attribute values, which are security information, there is information which is accumulated, such as a power on time and read/write error rates during magnetic disk drive operation; this information also must be maintained even when power is turned off.

Thus there is information in a magnetic disk device which must be updated after factory shipment, and which must be maintained even when power is turned off; this information is stored, as device-specific information, either in nonvolatile memory or in a system area on the media which cannot be accessed by users.

When power is turned on, the information, which had been updated/accumulated prior to the last time power was turned off, is loaded, and information must be updated/accumulated based on this loaded information. Hence when power is turned on, information must be read from nonvolatile memory or from a system area.

In such a magnetic disk device, as media capacities increase a huge amount of data is necessitated for defective sector management information, SMART information and others. These data are indispensable to access media in magnetic disk devices and for the normal execution of commands, and is stored in a device-specific area on the media.

The above data is read out in the power-on sequence, is held resident in memory, is updated during operation of the magnetic disk device, and is saved to a device-specific area of a disk either periodically, or upon receipt of a command, or with some other determined timing.

With the wide spread of mobile equipment in recent years, such disk storage devices have come to be installed in mobile equipment as well (for example, in notebook-type personal computers and in portable AV (audio/visual) equipment. In this usage environment, write errors tend to occur readily in disk devices, due to temperature changes, vibrations, or other causes. Consequently in such an environment, when a large quantity of device-specific information (for example, six to eight tracks' worth) is written to a system area on the media and saved, there is the possibility that the next time power is turned on it may not be possible to read out the device-specific information.

For example, in a state in which vibrations are imparted to a disk device, off-tracking may result, and there is the possibility that device-specific information cannot be written accurately to the track in question among the six or eight tracks. Hence if off-tracking occurs for even one track, overwriting or other problems may occur, and in the subsequent power-on sequence it will not be possible to read the device-specific information even if the head seeks to the track in question.

Similarly, due to the higher recording densities of recent years, differences in temperature tend to cause off-tracking, and if there are temperature changes in the writing and reading of device-specific information, write errors may arise during saving of device-specific information; if power is then turned off without taking any further action, a read error will occur when reading device-specific information in the subsequent power-on sequence.

Among the device-specific information of the disk device there also exists information which is essential to command execution, and if this information cannot be read out during the power-on sequence, normal operation may not be possible. Further, if device-specific information for which a read error has occurred is defect management information, normal media access cannot be guaranteed.

That is, in a device in which defective sector management information cannot be read and automatic replacement processing is occurring, the replacement source sector, rather than the replacement target sector, is accessed. The replacement source sector is the sector in which an error originally occurred, and data is written to the replacement target sector, so that a read error or data miss-compare occurs. And in cases in which defective sector information is registered in the defective sector management information at the time of shipment from the factory, accessing of defective sectors at the time of factory shipment also occurs.

Similarly, when SMART drive attributes cannot be read there no longer exist attribute values to be reported to a host through a SMART command, so that commands can no longer be executed.

When a disk device enters a state such as those described above, normal operation cannot be guaranteed, and so self-diagnostic errors occur and received commands are aborted. Further, when the disk device ends by aborting all commands issued from a host system or ends with an error, the host system may not be able to start up, and so it may not be possible to execute a task to backup data stored on the disk device. For example, if the disk device stores the host operating system (OS), the host can no longer read the OS from the disk device, and so cannot start up.

### SUMMARY OF THE INVENTION

Hence an object of this invention is to provide a processing method for prevention of device-specific information read errors and a media storage device, to prevent the occurrence of errors during the power-on sequence in reading device-specific information written to media, and to enable receipt of commands from a host.

Another object of this invention is to provide a processing method for prevention of device-specific information read errors and a media storage device, to perform read tests for updated device-specific information, to prevent the occurrence of read errors in the power-on sequence, and to enable receipt of commands from a host.

Still another object of this invention is to provide a processing method for prevention of device-specific information read errors and a media storage device, to detect device-specific information write errors during updates, prevent read errors in the power-on sequence, and enable receipt of commands from a host.

In order to attain these objects, a media storage device of this invention has a head, which performs reading and writing of data on tracks of storage media; an actuator, which positions the head at a desired track of the storage media; a memory, to store device-specific information; and a control unit, which when power is turned on positions the head in a system area of the storage media, reads the device-specific information stored in the system area, and expands the information into the memory, as well as receiving commands from a host, referencing the device-specific information in the memory, controlling the actuator, and using the head to execute reading or writing of data to or from the desired track. And the control unit, when not processing a command from the host, positions the head in the system area of the storage media, writes the device-specific information in memory to the system area, and performs updates, and when an update is performed, positions the head in the system area of the storage media and reads the device-specific information in the system area, to perform a read test.

Further, a read error prevention processing method of this invention is a processing method for prevention of errors in reading device-specific information for a media storage device, in which positions a head on a desired track of the storage media, and either reads or writes data. This prevention processing method has a step of positioning the head in a system area of the storage media when power is turned on, of reading the device-specific information stored in the system area, and of expanding the information into the memory; a step of receiving a command from a host, referencing the device-specific information in the memory, and using the head to execute either reading or writing of data from or to the desired track; a step, when a command from the host is not being processed, of positioning the head in the system area of the storage media, and of writing the device-specific information in the memory to the system area to perform an update; and a step, when the update is performed, of positioning the head in the system area of the storage media, and reading the device-specific information in the system area, to perform a read test.

In this invention, it is preferable that the control unit, upon detecting a read error in the read test, positions the head in the system area of the storage media, and writes the device-specific information in memory to the system area of the storage media using the head.

In this invention, it is preferable that the device-specific information have, at least, defective sector management information for the storage media.

In this invention, it is preferable that the device-specific information have, at least, defective sector management information for the storage media and SMART information.

In this invention, it is preferable that the control unit detects the fact that a command from the host has not arrived for a prescribed period of time, and executes processing to update the device-specific information.

In this invention, it is preferable that the control unit updates the device-specific information in the memory accompanying read/write execution, and, at least when power is turned off, writes the device-specific information in the memory to the system area of the storage media using the head.

In this invention, it is preferable that the control unit judges whether the timing for update of device-specific information as determined by a timer has arrived, and when the update timing has arrived, writes the device-specific information in the memory to the system area of the storage media.

In this invention, it is preferable that the control unit detects device-specific information read errors by performing a data error check.

In this invention, it is preferable that the storage media be a rotating magnetic disk.

In this invention, when command processing is not being performed in an idle loop after turning on power to a media storage device, processing to update the device-specific information is performed, to prevent loss of device-specific information due to sudden cutoff of power. In addition, when command processing is not being performed, the updated device-specific information is read from the media and a read test is performed, so that errors in reading the device-specific information upon power-on can be prevented, command reception and execution become possible, and a situation in which a host system cannot be started can be prevented.

### BRIEF DESCRIPTION OF THE DRAWINGS

FIG. 1 shows the configuration of the disk storage device of one embodiment of the invention;

FIG. 2 explains areas on the disk of FIG. 1;

FIG. 3 explains the device-specific information of FIG. 2;

FIG. 4 shows the access processing flow in the device of one embodiment of the invention; and

FIG. 5 shows the read test processing flow for the device-specific information of FIG. 4.

### DESCRIPTION OF THE PREFERRED EMBODIMENTS

Below, embodiments of the invention are explained, in the order of a media storage device, processing to prevent errors when reading device-specific information, and other embodiments.

Media Storage Device

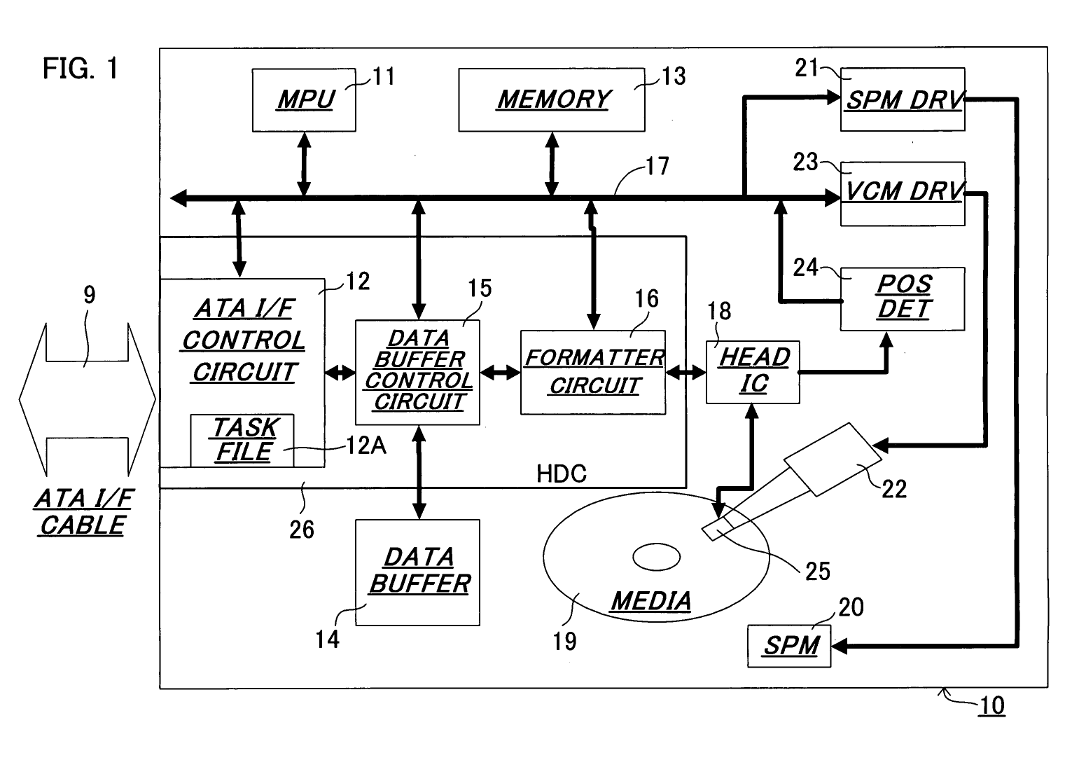

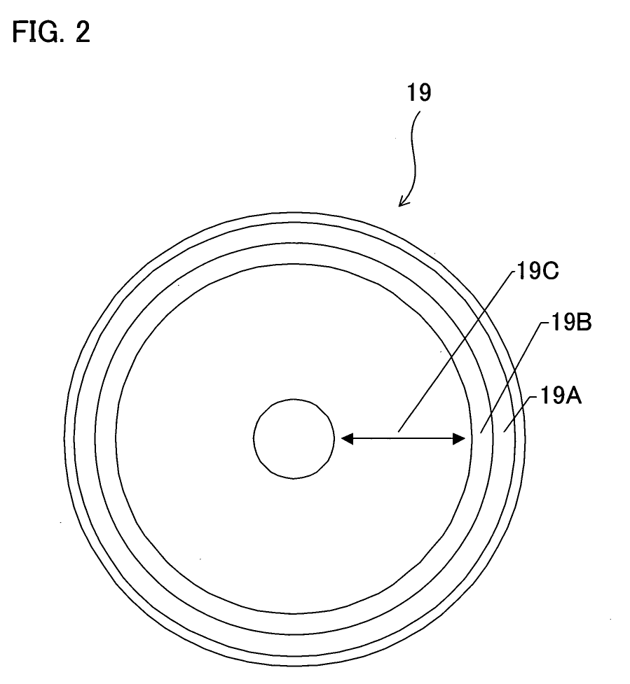

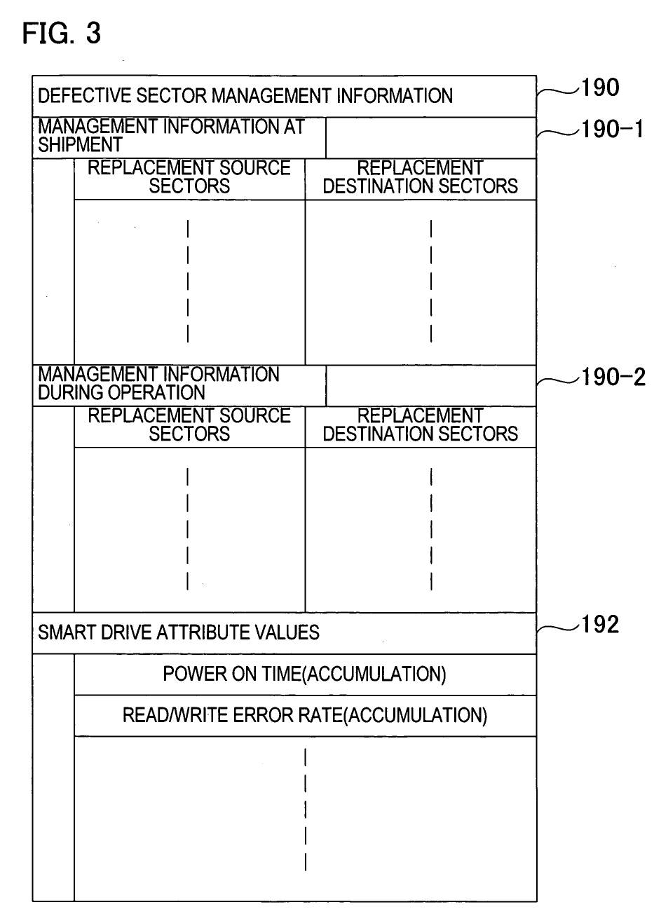

FIG. 1 shows the configuration of the media storage device of one embodiment of the invention, FIG. 2 explains the configuration of the storage media of FIG. 1, and FIG. 3 explains the device-specific information of FIG. 2. FIG. 1 shows, as an example of a media storage device, a magnetic disk device (Hard Disk Device) which reads and writes data from and to a magnetic disk.

The magnetic disk device 10 is incorporated in a personal computer, as shown in FIG. 1, and is connected to the personal computer host by an ATA (AT Attachment) specification interface cable 9.

The magnetic disk device 10 has a magnetic disk 19; a spindle motor 20 which rotates the magnetic disk 19; a magnetic head 25 which reads data from and writes data to the magnetic disk 19; and an actuator (VCM) which moves the magnetic head 25 in the radial direction of the magnetic disk 19 (track-traversing direction).

The control unit has an HDC (Hard Disk Controller) 26, a data buffer 14, a MPU 11, a memory (RAM) 13, a head IC 18, a spindle motor driver 21, a VCM driver 23, a position detection portion 24, and bus 17 connecting the former components.

The HDC 26 has an ATA interface control circuit 12 having a task file 12A which sets tasks from a host; a data buffer control circuit 15 which controls the data buffer 14; and a formatter control circuit 16 which controls the format of recording data.

During writing, the head IC 18 flows a write current to the magnetic head 25 according to the recording data, and during reading amplifies the read-out signal from the magnetic head 25 and outputs the read data (including servo information). The position detection portion 24 detects the position of the magnetic head 25 from the servo information from the head IC 18.

The spindle driver 21 drives rotation of the spindle motor 20. The VCM driver 23 drives the VCM 22, which moves the magnetic head 25. The MPU (microprocessor) 11 executes control of the position of the magnetic head 25, read/write control, and retry control. The memory (RAM) 13 stores data necessary for processing by the MPU 11.

FIG. 2 explains the data area of the magnetic disk 19. The data area is divided into a user data area (LBA0 to LBAn-1) 19C, which can be accessed by users, and system areas 19A, 19B outside the user data area. System area 19B is a device-specific information storage area, and stores device-specific information which is updated when the HDD is in operation.

As shown in FIG. 3, the updated device-specific information includes defective sector management information 190 and SMART drive attribute values 192. The defective sector management information 190 is a table of correspondences between replacement source sectors in which there are defects, and replacement target sectors. This defective sector management information 190 has management information 190-1 which is detected in tests of defective sectors at the factory and set at the time of factory shipment, and defective sector management information 190-2 which is detected during operation.

As the SMART drive attribute values 192, for example, the times power is turned on, read/write error rates, and similar are stored. After factory shipment, device-specific information at the time of factory shipment is written to the device-specific information storage area 19B, and during device operation, the device-specific information is updated. For example, in the device-specific information storage area 19B, the management information 190-2 during operation of the defective sector management information 190 is updated each time defective sector replacement processing is performed, and the SMART drive attribute values 192 are updated at power-off.

The MPU 11 in FIG. 1 reads the device-specific information area 19B of the magnetic disk 19 when power is turned on, and expands the information into the memory 13. The MPU 11 uses this device-specific information expanded into the memory 13 to identify defective sector position information on the media, performs read/write access of the magnetic disk 19, and executes replacement processing, at which time the device-specific information is updated. Similarly, the MPU 11 accumulates error rates and turn-on times, and updates SMART drive attribute values. Also, the SMART drive attribute values are transmitted to the host in response to a SMART command from the host.

During the power-off sequence, the MPU 11 writes the device-specific information which has been expanded into the memory 13 and updated to the device-specific information area 19B of the magnetic disk 19 and saves the device-specific information.

Processing to Prevent Errors 2hen Reading Device-Specific Information

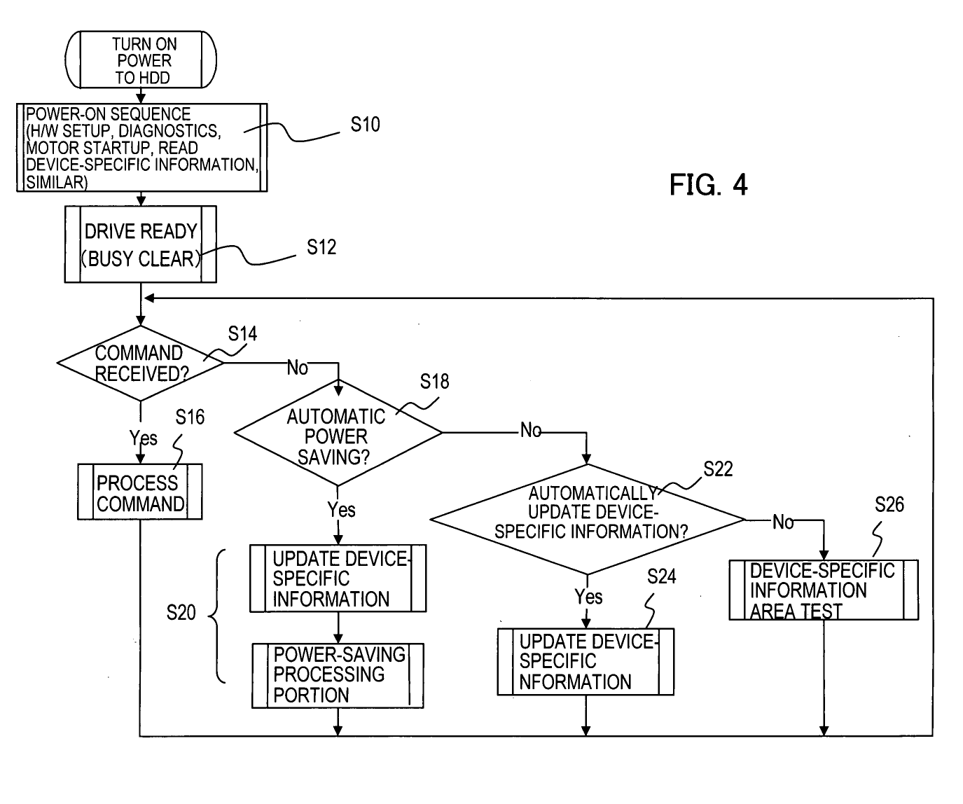

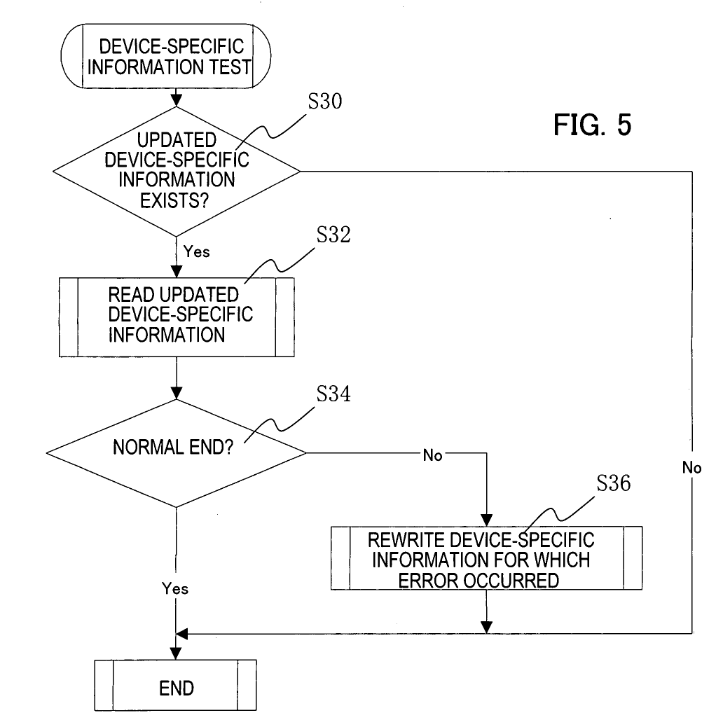

FIG. 4 shows the access processing flow in the media storage device of one embodiment of the invention, and FIG. 5 shows the processing flow for the device-specific information area test of FIG. 4.

(S10) After power is turned on, the MPU 11 executes the necessary initialization. That is, the MPU 11 performs hardware diagnostics, starts the spindle motor 20, and others. For example, diagnostics of the memory 13 and HDC 26 may be performed, and if the diagnostic results are satisfactory, the necessary initial settings are performed for register and the like, and the spindle motor 20 is started.

(S12) When startup of the spindle motor 20 is successful, the MPU 11 drives the VCM 22 via the VCM driver 23 to position the magnetic head 25 in the device-specific information storage area 19B of the magnetic disk 19. By this means, the magnetic head 25 executes reading of information in the device-specific information storage area 19B of the magnetic disk 19. The MPU 11 judges whether reading of device-specific information into the memory 13 has ended normally. If reading is judged to have ended normally, the busy signal is cleared. At this time, the read-out device-specific information is resident in the memory 13. After clearing the busy signal, processing enters an idle loop.

(S14) In the idle loop, first the MPU 11 judges whether the HDC 26 has received a command from a host.

(S16) Upon receipt of a command from a host, the MPU 11 controls the HDC 26 to execute command processing, and returns to step S14. As commands, in addition to data reading/writing, diagnostics and device-specific information writing can be specified.

(S18) If in step S14 the MPU 11 has judged that a command has not been received from a host, the MPU 11 judges whether a command has not been received continuously for a time set by the timer. That is, a judgment is made as to whether operation has entered automatic power saving.

(S20) The MPU 11 detects that commands have not been received continuously over the preset time, and enters automatic power saving; first, the MPU 11 writes the device-specific information in the memory 13 to the device-specific information storage area 19B on the magnetic disk 19 to perform an update. If in the HDD this writing is performed as read-after-write, then rotational latency occurs, and so writing alone is performed. That is, read checking is not performed. Power saving is then begun, that is, power is cut to all portions except the interface. Processing then returns to step S14.

(S22) On the other hand, if the MPU 11 judges that the power saving mode conditions have not been attained, the MPU 11 judges whether automatic update timing of the device-specific information has been reached. This automatic update timing is managed using timer values, and is executed with the timing set by the timer.

(S24) When the MPU 11 judges that the device-specific information automatic update timing has been reached, the MPU 11 writes the device-specific information in the memory 13 to the device-specific information storage area 19B of the magnetic disk 19, to perform an update. In the case of this writing also, if read-after-write of the HDD is performed, rotational latency occurs, and so writing only is performed. That is, read checking is not performed. Processing then returns to step S14.

(S26) On the other hand, if the MPU 11 judges that the automatic update timing for the device-specific information has not been reached, the MPU 11 performs test processing of the device-specific information area in FIG. 5. Processing then returns to step S14.

Next, FIG. 5 is used to explain test processing in step S26 of FIG. 4.

(S30) When the device-specific information is updated in steps S16, S20, and S24 of FIG. 4, the MPU 11 turns on an update flag in the memory 13. In this step the MPU 11 checks the update flag and judges whether the device-specific information has been updated. If the device-specific information has not been updated (if the update flag is off), processing ends. The update flag is stored in the memory 13, and is set and cleared by the MPU 11. (S32) On the other hand, if the MPU 11 judges that the device-specific information has been updated (if the update flag is on), the MPU 11 drives the VCM 22, and reads the updated device-specific information from the storage area 19B of the magnetic disk 19 using the head 25. (S34) The HDC 26 detects read errors in the read-out device-specific information by means of, for example, ECC or CRC checks. When a read error does not occur, the MPU 11 ends reading normally, turns off the update flag, and ends processing.

(S36) When on the other hand the HDC 26 detects a read error, the MPU 11 drives the VCM 22 and writes the device-specific information data resident in the memory 13 to the storage area 19B of the magnetic disk 19 using the head 25. Then the update flag is turned off, and processing ends.

Thus when a command is not being processed in an idle loop after power to the magnetic disk device is turned on, processing to update the device-specific information is performed. Therefore it is possible to prevent loss of device-specific information due to a sudden cutoff of power. And in addition the updated device-specific information is read from the media while no command processing is being performed, and a read test is executed.

In this read test, if a read error occurs the device-specific information in the memory 13 is re-written to the device-specific information storage area 19B on the media 19. By this means, errors in reading device-specific information at power-on are prevented in advance, and commands can be received.

### Other Embodiments

In the above embodiments, the device-specific information is explained in terms of the configuration in FIG. 3; but as SMART drive attribute values, other attribute values (threshold values adjusted automatically according to the drive conditions, setting information, and others) can be employed. Further, the media storage device was explained for the case of a magnetic disk device; but application to storage devices using optical disks, magneto-optical disks, or other storage media is also possible.

The interface is not limited to ATA, and application to other interfaces is possible. Moreover, steps S22 and S24 in FIG. 4 can be omitted.

In the above, embodiments of the invention have been explained, but the invention can be modified in various ways within the scope of the invention, and these modifications are not excluded from the scope of the invention.

When command processing is not being performed in an idle loop after turning on the power to a media storage device, update processing of device-specific information is performed to prevent loss of device-specific information due to a sudden cutoff of power; in addition, the updated device-specific information is read from the data and a read test is performed while command processing is not being executed, so that read errors of device-specific information during power-on can be prevented, and commands can be received and executed. Consequently a situation in which a host system cannot be started can be prevented, for effective results in application to a disk device to be used in an environment subject to vibrations and temperature changes.

What is claimed is:

1. A media storage device, comprising:
a head, which performs either reading or writing of data on tracks of a storage media;
an actuator, which positions said head at a desired track of said storage media;
a memory, which stores device-specific information; and
a control unit, which when power is turned on positions said head in a system area of said storage media, reads said device-specific information stored in said system area, expands said device-specific information into said memory, and receives commands from a host, references said device-specific information in said memory, controls said actuator, and uses said head to execute reading or writing of data to or from said desired track; and
wherein said control unit positions said head in said system area of said storage media, writes said device-specific information in said memory to said system area when not processing a command from said host to perform updates, and when said update is performed, positions said head in said system area of said storage media and reads said device-specific information in said system area, to perform a read test.

2. The media storage device according to claim 1, wherein said control unit, upon detecting a read error in said read test, positions said head in said storage media system area, and writes said device-specific information in said memory to said system area of said storage media using said head.

3. The media storage device according to claim 1, wherein said device-specific information comprises, at least, defective sector management information for said storage media.

4. The media storage device according to claim 1, wherein said device-specific information comprises, at least, defective sector management information and SMART information for said storage media.

5. The media storage device according to claim 1, wherein said control unit detects not to receive said host command during a prescribed interval, and executes processing to update said device-specific information.

6. The media storage device according to claim 1, wherein said control unit updates said device-specific information in said memory upon execution of said reading/writing, and writes said device-specific information in said memory to said system area of said storage media using said head at least at the time power is turned off.

7. The media storage device according to claim 1, wherein said control unit judges whether the timing for update of said device-specific information as determined by a timer has arrived, and when the update timing has arrived, writes the device-specific information in said memory to said system area of said storage media.

8. The media storage device according to claim 1, wherein said control unit detects said device-specific information read errors by performing a data error check.

9. The media storage device according to claim 1, wherein said storage media is a rotating magnetic disk.

10. A processing method for preventing errors in reading device-specific information for a media storage device which positions a head at a desired track of said storage media and either reads or writes data of said storage media, said method comprising the steps of:
positioning said head in a system area of said storage media when power is turned on, reading said device-specific information stored in said system area, and expanding the information into a memory;
receiving a command from a host, referencing said device-specific information in said memory, and using said head to execute either reading or writing of data from or to said desired track;
positioning said head in the system area of said storage media, and of writing the device-specific information in said memory to said system area to perform an update when a command from said host is not being processed; and
positioning said head in the system area of said storage media, and reading the device-specific information in said system area when said update is performed, to perform a read test.

11. The processing method for preventing errors in reading device-specific information for a media storage device according to claim 10, further comprising:
a step, upon detecting a read error in said read test, of positioning said head in said storage media system area; and
a step of writing device-specific information in said memory to said system area of said storage media using said head.

12. The processing method for preventing errors in reading device-specific information for a media storage device according to claim 10,
wherein said step of expansion into said memory comprises a step of expansion of device-specific information having, at least, defective sector management information for said storage media.

13. The processing method for preventing errors in reading device-specific information for a media storage device according to claim 10,
wherein said step of expansion into memory comprises a step of expansion of device-specific information having, at least, defective sector management information and SMART information for said storage media.

14. The processing method for preventing errors in reading device-specific information for a media storage device according to claim 10,
wherein said update step comprises:
a step of detecting not to receive said host command within a prescribed interval; and
a step of executing processing to update said device-specific information.

15. The processing method for preventing errors in reading device-specific information for a media storage device according to claim 10, further comprising:
a step of updating device-specific information in said memory upon execution of said reading/writing; and
a step of writing device-specific information in said memory to said system area of said storage media using said head at least at the time power is turned off.

16. The processing method for preventing errors in reading device-specific information for a media storage device according to claim 10, wherein said update step comprises:
a step of judging whether the timing for update of device-specific information as determined by a timer has arrived; and
a step, when the update timing has arrived, of writing the device-specific information in said memory to said system area of said storage media.

17. The processing method for preventing errors in reading device-specific information for a media storage device according to claim 10,
wherein said read test step comprises a step of detecting said device-specific information read errors by performing a data error check.

18. The processing method for preventing errors in reading device-specific information for a media storage device according to claim 10,
wherein said storage media is a rotating magnetic disk.
